(19) United States
(12) Patent Application Publication
(10) Pub. No.: US 2013/0041712 A1
(43) Pub. Date: Feb. 14, 2013

(54) EMERGING RISK IDENTIFICATION PROCESS AND TOOL

(71) Applicants: Katherine Fowler Smoot, Charlotte, NC (US); Nilakshana Mahasal Jayanetti, Matthews, NC (US)

(72) Inventors: Katherine Fowler Smoot, Charlotte, NC (US); Nilakshana Mahasal Jayanetti, Matthews, NC (US)

(73) Assignee: Bank of America Corporation, Charlotte, NC (US)

(21) Appl. No.: 13/206,251

(22) Filed: Aug. 9, 2011

(51) Int. Cl. G06Q 10/00

(52) U.S. Cl. 705/7.28

(57) ABSTRACT

Managing risks may include receiving multiple issues associated with an enterprise where each issue is a future risk or a current risk, storing the issues, aggregating the issues, filtering the issues by executing a predefined rule set to determine a set of issues for analysis, creating a report including the set of issues for analysis, and transmitting the report to a user. Managing risk may also include determining a status of an action item associated with an issue in the set of issues, monitoring open issues and associated action items, and removing any closed issues.

### TECHNICAL FIELD

The present disclosure generally relates to risk management, and more particularly to the management of risks within an enterprise.

### BACKGROUND

Certain enterprises must comply with various industry and government regulations to reduce the level of risk affecting the organization. Risk management and assessment affect business decisions made in a number of sectors, such as the banking industry. Commercial entities continuously assess risk and monitor risk mitigation efforts to ensure compliance and efficient operation of their business.

### SUMMARY

In accordance with the present disclosure, disadvantages and problems related to managing risk within an enterprise may be reduced or eliminated.

According to one embodiment, managing risks include receiving multiple issues associated with an enterprise where each issue is a future risk or a current risk, storing the issues, aggregating the issues, filtering the issues by executing a predefined rule set to determine a set of issues for analysis, creating a report including the set of issues for analysis, and transmitting the report to a user. In some embodiments, managing risk may also include determining a status of an action item associated with an issue in the set of issues, monitoring open issues and associated action items, and removing any closed issues.

Certain embodiments of the present disclosure may provide one or more technical advantages. A technical advantage of one embodiment includes maintaining an aggregated and consistent perspective of issues within a business unit or across an enterprise that is accurate and transparent. In particular embodiments, this helps ensure that issues and future/emerging issues are well understood and addressed within an enterprise, with the positive intent to mitigate exposure to the enterprise. The regular reporting and assessment of issues facilitates remediation of current and future risks within increased speed and in a timely manner. Another technical advantage of an embodiment includes automatically converting future issues into current issues based on parameters associated with the issues data. This further enables users in an organization to evaluate issues based on their impact date, priority, severity, or other criteria identified by the organization. Yet another technical advantage of an embodiment includes creating action items to define a measurable review of risk mitigation that provides management with indicators necessary to promote effective mitigation control plans and help drive current and future investment decisions. This may also assist management in creating incentives for achieving particular risk mitigation milestones.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example environment for managing issues.

FIG. 2 illustrates an example embodiment of a issues management module.

FIG. 3 illustrates an example embodiment of an issues management interface for providing issues information.

FIG. 4 illustrates an example embodiment of an issues management interface for searching managed issues satisfying specified criteria.

FIG. 5 illustrates a flowchart of an example embodiment.

### DETAILED DESCRIPTION

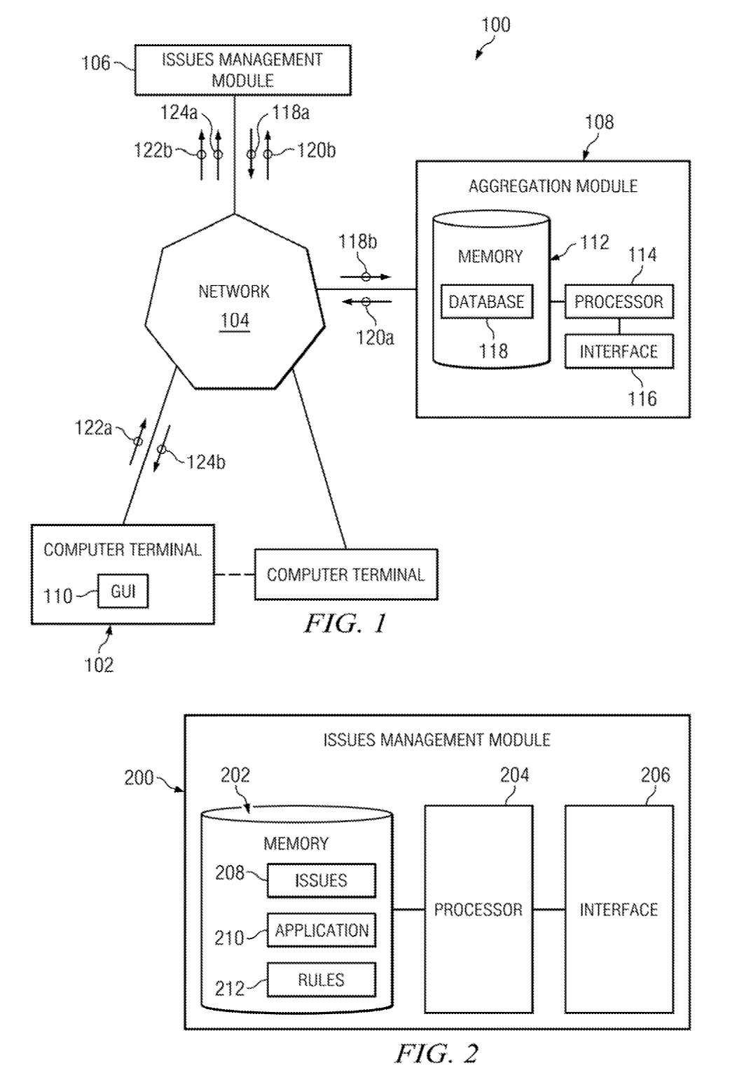

Embodiments of the present disclosure and the advantages are best understood by referring to FIGS. 1-5, like numerals being used for like and corresponding parts of the various drawings.

FIG. 1 illustrates a system 100 that collects various issues associated with an enterprise, aggregates them, filters them, and prepares a report for analysis by multiple users. In particular embodiments, issues may include current risks and future risks to the organization. A current risk may be a risk to the enterprise that has the potential to cause or has caused an adverse impact to the achievement of business objectives within a certain level and should be immediately considered for remediation. Various types of current risks may include regulator-identified issues, audit issues, and internally-identified issues. Internally-identified issues may include those issues separately identified by risk associates, approved delegates, or other users in a particular line of business. Future risks are those emerging risks that are developing exposures in the external and internal environment that could have significant impacts on business objectives, strategy, and performance. The external environment includes economic, political, regulatory, legal, customer/clients, supplier, and demographic risks. The internal environment includes people, process, system, and other relevant risks. In particular embodiments, a future risk may be limited to a specific future period of time, such as within six months to a three year time horizon. For example, a future risk may be a risk resulting from a global or industry-wide instability or fluctuations in the market. The identification and measurement of future risk may drive decisions on risk mitigation, consistent with the management-approved risk levels. A current risk or future risk may be separately categorized as a reputational risk based on its potential reputationally damage the enterprise. For example, reputational risk may include negative publicity regarding an enterprises' conduct, or business practices, that can adversely affect its profitability, operations, or customer base, or require costly litigation or other defensive measures.

In particular embodiments, users of embodiments of the present disclosure may include a risk associate, a risk assessment committee, a manager, a Chief Risk Officer (CRO), a CRO forum, or the board of directors for an enterprise. For example, a CRO forum may include a number of risk personnel and management and be responsible for discussing key issues, future/emerging issues, and the related reputational risks to identify themes and to ensure appropriate action is taken. The forum may also be responsible for prioritization of key issues, future/emerging issues, and reputational risks, including assigning ownership of decisions and actions. Components of system 100 may be operable to collect action items, priorities, and detailed analysis resulting from the forum discussion and analysis. Accordingly, system 100 may facilitate collection of issues data and associated parameters before and after the analysis of the issues. In particular embodiments, a CRO forum may be conducted on monthly, semi-monthly, or other periodic basis, or when a number of issues for analysis reach a particular threshold or priority/severity level.

As illustrated, system 100 includes one or more computer terminals 102 that communicate over a network 104 to facilitate aggregation of issues and the performance of various other processing functions including filtering issues based on predefined rules to determine a set of issues for analysis and creating a report for analyzing the issues. Computer terminals 102 may interact with issues management module 106 to conduct various processing activities with respect to the issues. Issues management module 106 interacts with aggregation module 108 to collect issues and to process the issues for inclusion in a risk report for multiple users. Aggregating and processing various types of issues for inclusion in a report enables various users receiving the report to consider the underlying current or future risk to the enterprise and effectively mitigate the risk associated with those issues.

In particular embodiments, an enterprise may include an aggregation module 108 to collect and maintain issues from multiple business units within the enterprise. In particular embodiments, issues received from various business units may have differing formats. Aggregation module 108 may collect issues from computer terminals 102 or various data servers associated with individual business units or lines of business. The aggregation of issues by aggregation module 108 enables issues management module 106 to consistently process issues for presentation in a report to various users. The recipients of such a report may include upper management, risk compliance officers and various other stakeholders in the enterprise.

Computer terminals 102 represent general purpose computers including appropriate hardware, control logic, and data that may be used to interface with other system components, such as issues management module 106 or aggregation module 108, using network 104. For example, computer terminals 102 may represent work stations, laptops, netbooks, tablet computers, personal data assistants (PDAs), mobile phones and any other suitable computing device. Computer terminals 102 may support a wide array of operations, including but not limited to, web browsing, word processing and managing issues and risks in an enterprise. According to particular embodiments, computer terminals 102 may provide access, potentially through web based interfaces, to information managed by other elements such as issues management module 106 and aggregation module 108. As illustrated 102 may include a graphical user interface 110. Graphical user interface 110 represents any appropriate interface for receiving and displaying information to a user of system 100. Graphical user interface 110 may be any appropriate combination of hardware and/or software to facilitate a user's interaction with computer terminals 102.

Network 104 represents any suitable communications network operable to facilitate the communication between the components 100, such as computer terminals 102, aggregation module 108, and issues management module 106. Network 104 may include any interconnecting system capable of transmitting audio/video signals, data, messages or any other suitable combination of the preceding. Network 104 may include all or a portion of a public switch telephone network (PSTN), a public or private data network, a local area network (LAN), a metropolitan area network (MAN), a wide area network (WAN), a local, regional, or global communication or computer network, such as the Internet, a wireline or wireless, an enterprise intranet, or any other suitable communication link, including combinations thereof, operable to facilitate communication between components of system 100. Network 104 may include any combination of gateways, routers, hubs, switches, access points, base stations, wireless telephone systems and any other hardware, software or a combination thereof.

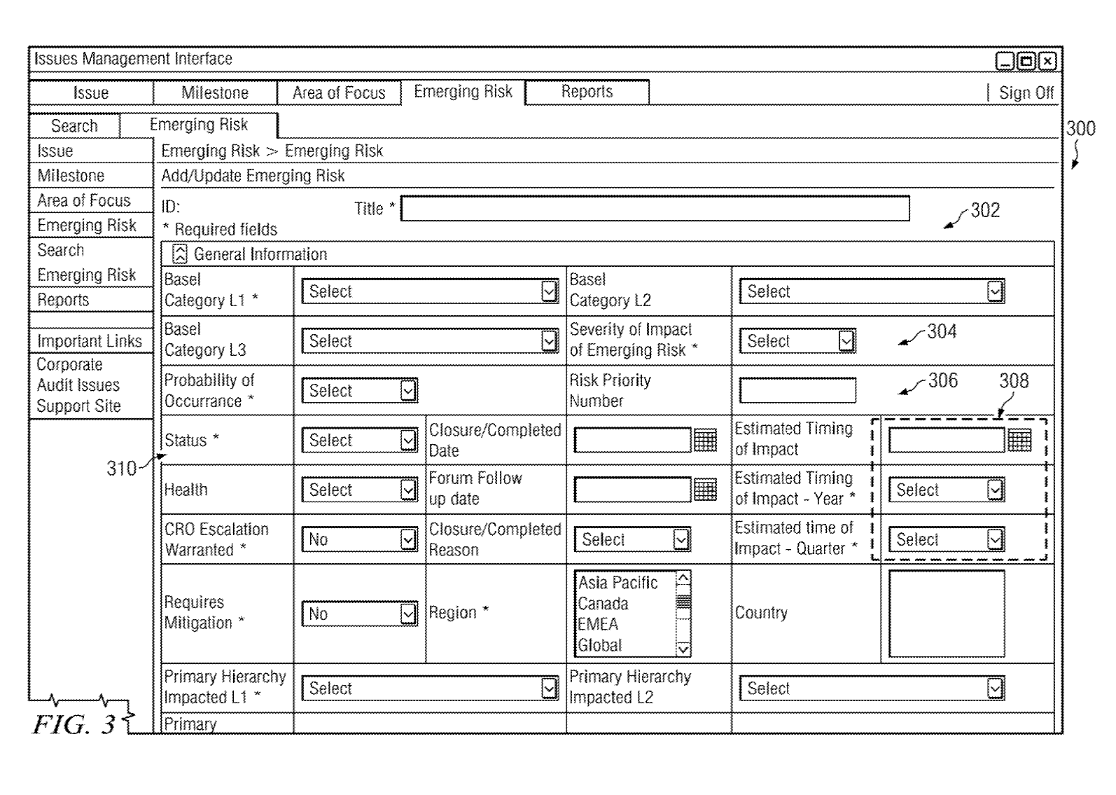

Issues management module 106 represents suitable hardware components, controlled logic, and data for receiving issues from aggregation module 108 corresponding to current and future risks associated with particular business units of an enterprise and from computer terminals 102. As illustrated, issues management module 106 may be communicatively coupled to other components of system 100, such as aggregation module 108 and computer terminals 102, by a network 104. In particular embodiments, issues management module 106 may be operable to process issues and facilitate presentation of current and future risk in a report to various users at computer terminals 102. Issues management module 106 will be discussed in further detail in FIG. 2.

Aggregation module 108 represents suitable hardware components, control logic, and data for managing issues in an enterprise. For example, aggregation module 108 may be any suitable combination of computer servers and networking devices whether real or virtual. Aggregation module 108 may collect and manage issues, which may include various types of risks including current risks, future risks and reputational risks organizing from different lines of business within the organization. For example, aggregation module 108 may maintain issues related to various business units and include current and future risks associated with particular aspects of one or more business units. In other embodiments, aggregation module 108 may be organized to maintain additional or other categories of risk associated with the enterprise. In certain embodiments, aggregation module 108 may maintain issues in different formats depending on the type of risk or the originating business unit. In other embodiments, aggregation module 108 may maintain issues that apply consistently across the organization and independent of specific business units.

As illustrated, aggregation module 108 may include various interconnected elements including a memory 112, a processor 114, and an interface 116. Memory 112 represents any suitable combination of volatile or non-volatile, local or remote devices suitable for storing information. For example, memory 112 may include random access memory (RAM), read-only memory (ROM), magnetic storage devices, optical storage devices, or any other suitable information storage device or a combination of such devices. Memory 112 may maintain appropriate control logic and rules for controlling the operation of aggregation module 108. As illustrated, memory 112 may include a database 118 for storing and organizing various types of issues of risks. In particular embodiments, database 118 represents a relational database for storing issues in an easily retrievable manner. For example, database 118 may represent an SQL database for storing various types of information including issues for an enterprise.

Processor 114 represents any hardware and/or software that communicatively couples to memory 112 and interface 116, and controls the operation and administration of aggregation module 108. For example, processor 114 may execute appropriate software to control the operation of aggregation module 108. Processor 114 may be a programmable logic device, a micro controller, a micro processor, any other appropriate processing device, or any suitable combination of the preceding.

Interface 116 represents any suitable device operable to receive information from network 104, transmit information through network 104, perform processing of received or transmitted information, communicate to other devices or any combination of the preceding. Interface 116 represents any port or connection, real or virtual, including any suitable hardware and/or software including protocol conversion and data processing capabilities to communicate through a LAN, WAN or other communications systems that allow aggregation module 108 to exchange information with network 104, computer terminals 102 and issues management module 106. For example, interface 116 may receive the requests for database transactions associated with database 118 from computer terminals 102. According to particular embodiments, interface 116 may receive issues from computer terminals 102 for appropriate processing by processor 114 and storage in database 118 of memory 112. In other embodiments, aggregation module 108 is operable to collect issues from various data servers associated with different lines of business and/or computer terminals 102 at the instruction of processor 114.

In exemplary embodiments, issues management module 106 communicates request 118 to aggregation module 108 through network 104 requesting issues data. As discussed above, the issues may include current and future risks associated with various business units and/or the enterprise. In certain embodiments, the representation of the issues may vary in data format. For example, the data format may vary depending on the originating business unit or the type of risk being tracked. In response to request 118, aggregation module 108 transmits response 120, which includes the requested issues data. Issues management module 106 receives the issues data and performs various functions on the data, such as aggregation, filtering, and preparing a report for analysis of the issues by users. Also, as discussed above, certain embodiments may involve aggregation module 108 receiving issues data from computer terminals 102. In other embodiments, issues management module 106 may receive issues data from computer terminals 102 using a similar process.

In particular embodiments, computer terminals 102 transmit request 122 to issues management module 106 through network 104 for processing issues data. In response to request 122, issues management module 106 may communicate response 124, which includes the requested, processed issues data. In certain embodiments, issues management module 106 aggregates multiple issues, filters the issues based on a predefined rules set to determine the set of issues for analysis, and creates a report comprising the set of issues. In some embodiments, the prepared report may be transmitted to appropriate users at computer terminals 102. In other embodiments, appropriate users at computer terminals 102 may receive a prepared report on a periodic basis or some other defined schedule. For example, various users who are responsible for risk mitigation may receive a report on a regular schedule in advance of a chief risk officer forum or other risk remediation meeting. For example, such reports may define an agenda of topics to be analyzed at a monthly leadership forum to discuss key enterprise issues and emerging risks.

In certain embodiments, issues management module 106 may send reports to appropriate users based on their role in the risk or remediation hierarchy. For example, certain members of management and specific risk compliance officers throughout the enterprise and within individual business units may receive the report upon request or on a periodic basis. Receiving such a report that is consistent throughout the organization enables these individuals to appropriately address risk in a timely fashion and develop action items as necessary to monitor risk remediation activities. The processing of issues and preparation in a report facilitates risk mitigation throughout the entire organization. In some instances, issues may be monitored through final mitigation. In particular embodiments, monitoring includes tracking issues, establishing workflows, monitoring progress, and reporting. Accordingly, embodiments of the present disclosure may operate to enhance the analysis, aggregation, and prioritization of emerging risks, including ensuring accountability for identifying, mitigating, monitoring, and reporting current and future issues.

As discussed above, the issues may be filtered according to a predefined rule set. For example, a predefined rule set may include instructions to determine which issues to include in the report transmitted to the user. In certain embodiments, the predefined rule set is configurable, which enables the enterprise to specify how issues are defined, prioritized, and escalated to particular users, such as management and the board of directors, for analysis and discussion. Issues management module 106 may also include certain conversion rules to evaluate a future risk and convert it into a current risk, provided that appropriate conditions have been met. For example, a future risk may have an associated estimated impact date representing a future date on which the future risk will have an organizational impact. When such an impact date has passed, the conversion rules of issues management module 106 may convert the future risk into a current risk for the enterprise. In other embodiments, the conversion of a future risk into a current risk may be based on risk severity, risk probability, line of business priority, and/or estimated impact date.

A component of system 100 may include an interface, logic, memory, and/or other suitable elements. An interface receives input, sends output, processes the input and/or output and performs other suitable operations. Interface may comprise hardware and/or software. Logic performs the operation of the component, for example, logic executes instructions to generate output from input. Logic may include hardware, software, and/or other logic. Logic may be encoded in one or more non-transitory tangible media, such as computer-readable medium or any other suitable tangible medium, and may perform operations when executed by a computer. Certain logic, such as a processor, may manage the operation of a component. Examples of processor include one or more computers, one or more micro processors, one or more applications, and/or other logic. Any suitable logic may perform the functions of system 100 and the components within system 100.

Accordingly, in certain embodiments, system 100 provides a centralized issue and emerging risk repository. While system 100 is illustrated as including specific components arranged in a particular configuration, it should be understood that various embodiments may operate using any suitable arrangement and collection of components capable of providing functionality such as that described.

FIG. 2 illustrates a system 200, representing a particular embodiment of an issues management module 106 that receives data and processes it according to particular control logic. In particular embodiments, system 200 represents a proprietary Bank of America issues management module that facilitates management of current and future risks associated with various business units within the enterprise.

As illustrated, system 200 may include various interconnected elements including a memory 202, a processor 204, and an interface 206. Memory 202 stores, even a permanently or temporarily, data, operational software or other information for processor 204.

Memory 202 represents any suitable combination of volatile or non-volatile, local or remote devices suitable for storing information. For example, memory 202 may include RAM, ROM, magnetic storage devices, optical storage devices, or any other suitable information storage device or a combination of such devices. As illustrated, memory 202 includes issues 208, application 210, and rules 212 to facilitate processing of issues data. Issues 208 represent data associated with current and future risk collected from other components, such as aggregation module 108 and computer terminals 102. In particular embodiments, issues 208 may be organized as a database, such as SQL database, capable of managing, maintaining, and organizing issues data. In particular embodiments, issues data may be stored in the database as having various associated fields for each current and future issue. For example, the type of risk may be indicated by a particular data field and the severity or the priority of the risk may be indicated by another data field. Other example fields may identify whether a risk is a current or future risk and whether a risk is a reputational risk. An issue may also be stored in a database as being associated with an estimated impact date. As discussed above, the estimated impact date may represent a future date on which a future risk becomes a current risk to the enterprise.

Application 210 generally refers to logic, rules, algorithms, code, tables and/or other suitable instructions for performing the described functions and operations of system 200. In certain embodiments, application 210 may facilitate the interaction of system 200 with aggregation module 108 and computer terminals 102 using network 104.

Rules 212 generally refer to logic, rules, standards, policies, limitations, tables, and/or other suitable instructions for processing the received issues data from aggregation module 108 and/or computer terminals 102. Rules 212 may include logic to process the application governance data into an aggregated format, filter the data based on the predefined rules set, and create a report including a set of issues for analysis for various users within the organization. In particular embodiments, a pre-defined rules set establishes the criteria for determining which issues should be presented in a report for analysis by users. For example, the report transmitted to the user would include those issues identified as significant for reporting to the user. As one example, a predefined rules set may establish the levels of priority or specific dates that are significant for specific users in a particular report or during a particular reporting period. In those embodiments, the predefined rules set facilitates narrowing the set of issues to those that are most significant for consideration, analysis and/or remediation. Rules 212 may also include conversion rules establishing the criteria for when a future risk should be converted into a current risk. For example, a future risk may be converted into a current risk based on the risk severity, risk probability, line of business priority, and/or the estimated impact date. The conversion rules may be used in conjunction with the predefined rules set to ensure that reports prepared for users in the enterprise are accurate and up-to-date given the various parameters associated with each of the issues, such as risk type and risk severity.

Processor 204 represents any hardware and/or software that communicatively couples to memory 202 and interface 206, and controls the operation and administration of system 200. For example, processor 204 may execute appropriate instructions, control logic, and rules in application 210 to control the operation of system 200. According to particular embodiments, processor 204 may be a programmable logic device, a microcontroller, a microprocessor, and/or any other appropriate processing device, or any suitable combination of the proceeding.

Interface 206 represents any suitable device operable to receive information from the communication network such, as network 104, transmit the information on the network, perform processing of received or transmitted information, communicate with other devices, or any combination of the proceeding. Interface 206 may be any port or connection, real or virtual, including any suitable hardware and/or software including protocol conversion and data processing capabilities to communicate through a LAN, WAN or other communication systems that allow system 200 to exchange information with other devices over a communication network. For example, interface 206 may enable system 200 to communicate with other devices and systems, such as computer terminals 102 and aggregation module 108 over network 104. According to particular embodiments, interface 206 may receive issues data from aggregation module 108 and/or computer terminals 102. In some embodiments, interface 206 may receive requests for an issues report as prepared by processor 204 following various processing steps, such as aggregation and filtering. In other embodiments, interface 206 may periodically transmit reports to various users at computer terminals 102 according to a predetermined schedule.

In operation, processor 204 interacts with interface 206 to receive issues data from aggregation module 108. The issues data received from aggregation module 108 may have specific formats and vary in type, priority, and severity. Processor 204 may store the received data as issues 208 in memory 202. In particular embodiments, processor 204 aggregates the various issues, filters the issues by executing a predefined rule set to determine the issues for analysis, and generates a report identifying those issues for analysis. The predefined rule set may be derived from rules 212 of memory 202. In some embodiments, the predefined rule set establishes the issues that should be included in the report to users.

In certain embodiments, processor 204 may receive requests for the report from users at computer terminals 102 on interface 206. In response, processor 204 may execute specific control logic defined by application 210 to transmit the requested report after proper aggregation and filtering to the users at computer terminals 102. In other embodiments, system 200 may deliver one or more reports to various users based on a predetermined schedule.

Processor 204 may also execute specific control logic within application 210 to determine an action item associated with each issue in the set of issues for analysis. In particular embodiments, this may be indicated on a report sent to a user. Establishing such an action item may enable system 200 to monitor the status of each issue and determine whether the issue has been resolved. For example, if the status of an action item associated with an issue in the set of issues for analysis is determined to be open, processor 204 may execute logic to monitor the issue and the associated action item. If the status of the action item is closed, however, processor 204 may remove the issue from the set of issues. By enabling action items for particular issues, system 200 allows users within an enterprise to continuously monitor risk even following the identification of a particular issue in a report to the user. This ensures that a particular issue is tracked appropriately following analysis and during the remediation phase.

While system 200 is illustrated as including specific components arranged in a particular configuration, it should be understood that various embodiments may operate using any suitable arrangement and collection of components capable of providing functionality such as that described.

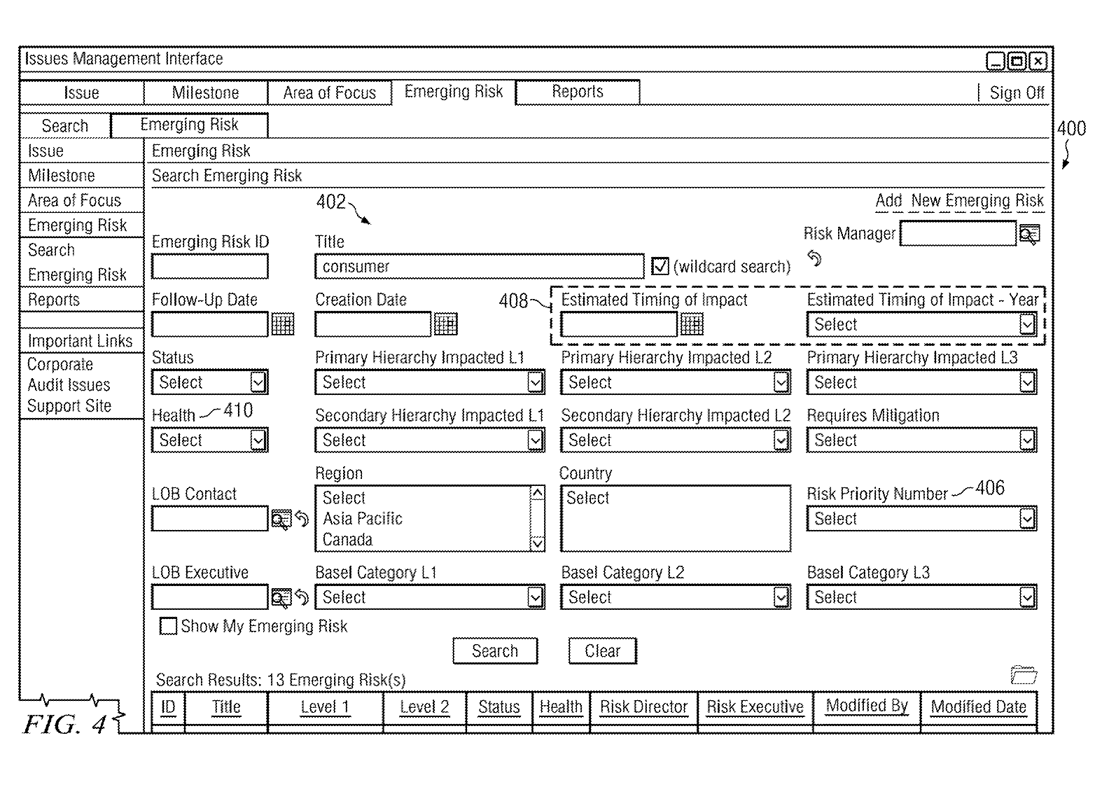

FIG. 3 illustrates an example screenshot 300 for adding or updating a future risk. In the example screenshot, an emerging risk is a future risk. Screenshot 300 may be one embodiment of an issues management interface accessible to users at various computer terminals 102 for adding or updating a particular emerging risk. As illustrated, screenshot 300 includes a number of fields including title field 302, severity of impact field 304, risk priority number field 306, estimated timing of impact field 308, and status field 310. In the illustrated embodiment, the title field 302 providing for entering or updating the name or ID assigned to a particular emerging risk. The severity of impact field 304 allows the user to enter a severity value such as sev 1, sev 2, or sev 3 to indicate the level of severity associated with the emerging risk. In a similar fashion, the risk priority number field 306 allows the user to specify the priority associated with this particular emerging risk. The estimated timing of the impact field 308 represents a field to enter the date the particular emerging risk is expected to impact a line of business or enterprise. As illustrated, the estimated timing of impact could be specified as a date, a year or a particular quarter. Screenshot 300 also has a status field 310 for indicating whether the emerging risk is open or closed. Screenshot 300 shows a plurality of other fields that are relevant for analyzing a risk, preparing meaningful reports for analysis, and mitigating risk throughout the enterprise.

In operation, entering the required fields of screenshot 300 may cause computer terminals 102 to send issues data to aggregation module 108 for storage in memory. Issues management module 106 may later obtain this emerging risk from aggregation module 108 for further analysis and determination of whether it should be included in a report to a user. In particular embodiments, screenshot 300 may be presented using a graphical user interface 110 of computer terminals 102 over a web interface for adding or updating emerging risk by appropriate risk or audit associates.

While system 300 is illustrated as including specific components arranged in a particular configuration, it should be understood that various embodiments may operate using any suitable arrangement and collection of components capable of providing functionality such as that described.

FIG. 4 illustrates an example of screenshot 400 of an issues management interface for requesting emerging risks managed by issues management module 106 that satisfy specified search criteria. Screenshot 400 may be one embodiment of a user interface in which a user views the results of a particular search of emerging risks stored in issues management module 106 and/or issues aggregation module 108.

As illustrated, screenshot 400 includes various fields such as title field 402, risk priority number 406, estimated timing of impact field 408, and status field 410. As discussed above with respect to screenshot 300, these fields may have specific values. In particular embodiments, a user may issue a search by entering values for one or more of the fields shown in screenshot 400 to display results satisfying that criteria. For example, a user at computer terminals 102 may be presented with this issues management interface and enter specific criteria using graphical user interface 110 to obtain emerging risks that match the search criteria specified by the user.

In operation, a user may specify particular values for title field 402 (e.g., “consumer”), estimated timing of impact in terms of a date or year (e.g., 2011), risk priority number 406 (e.g., “1”), and status field 410 (e.g., “open”). In such an embodiment, when the user issues such a request, computer terminals 102 forward the request to issues management module 106. In response, issues management module 106 returns a list of emerging risks that have parameters that meet the indicated criteria. The results of a search through the issues management interface may be presented in a table format indicating various values including the ID, the title, one or more levels, the status, the health, the risk director, the risk executive and the modified personnel and date. Using the issues management interface illustrated in screenshot 400, a user may search for and obtain information corresponding to specific emerging risks outside the context of normal issues reporting or between predetermined reporting schedules.

While screenshot 400 is illustrated as including specific components arranged in a particular configuration, it should be understood that various embodiments may operate using any suitable arrangement and collection of components capable of providing functionality such as that described.

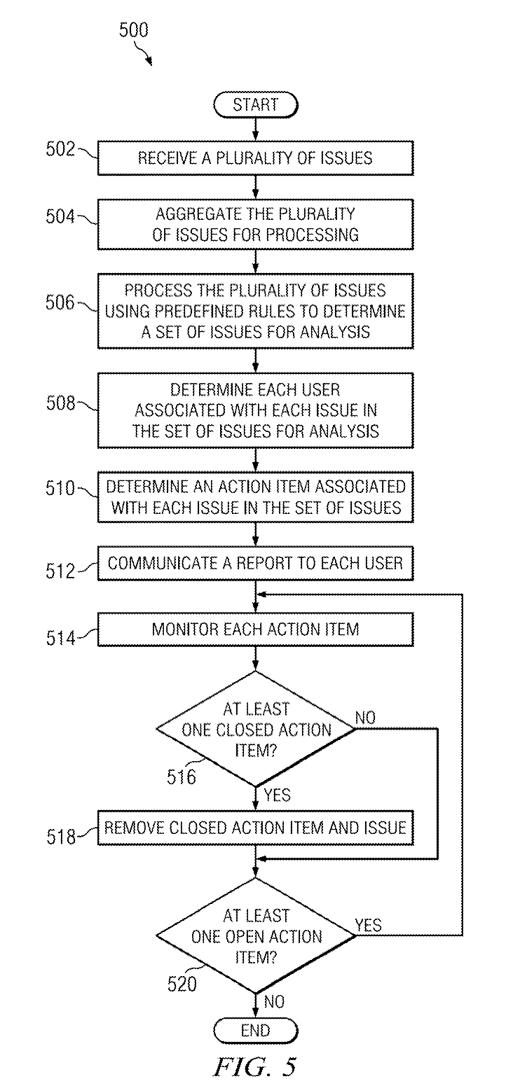

FIG. 5 illustrates a flow chart 500 for processing issues associated with an enterprise. The method begins in step 502 where issues management module 106 receives a plurality of issues. As discussed above, issues data may be obtained from aggregation module 108 or computer terminals 102 using a network 104. Each issue may be either a current risk or a future risk affecting the enterprise. Each risk may also include multiple fields identifying various parameters associated with the risk. Exemplary fields associated with a particular risk may include the risk severity, risk probability, the line of business priority, and the estimated impact date.

At step 504, issues management module 106 aggregates the plurality of issues for processing. This step may include updating current risks or future risks as necessary for later reporting. Next, in step 506, the plurality of issues may be processed using predefined rules to determine a set of issues for analysis. For example, processing may include filtering the plurality of issues according to predefined rules that establish a set of issues for analysis and also determine which issues to include in a later report. At step 508, issues management module 106 determines each user associated with each issue in the set of issues for analysis. In particular embodiments, this step involves issues management module 106 determining a risk director or a risk executive associated with an issue so that a report can be later communicated to that user.

Issues management module 106 next determines appropriate action items for each issue in the set of identified issues. Establishing an action item enables later monitoring of the action item so that an issue is not later overlooked and instead is properly addressed within the risk mitigation framework of the enterprise. In step 512, a report is communicated by issues management module 106 to each identified user. As discussed above, a user may have been identified as associated with an issue in a set of issues for analysis in step 508.

At step 514, embodiments of issues management module 106 monitor each action item associated with an issue to determine whether the status of the action item is closed or remains open. In particular embodiments, monitoring continues until all open action items are closed. Accordingly, at step 516, issues management module 106 may determine whether at least one action item has closed. If at least one action item is closed, issues management module 106 removes the closed action items and issues in step 518. Once all closed action items and issues are removed or alternatively, if no action items remain, issues management module 106 determines at step 520 whether at least one open action item remains for monitoring. If at least one action item remains open, issues management module 106 returns to step 514 and continues to monitor each open action item. Otherwise, there are no more action items to monitor and the method ends at step 520.

Modifications, additions, or omissions may be made to the flow chart. For example, a user may issue a specific request for a report before or after the most recent issues have been collected from aggregation module 108 and/or computer terminals 102. Additionally, steps in FIG. 5 may be performed in parallel or in any suitable order.

Certain embodiments of the present disclosure may provide one or more technical advantages. A technical advantage of one embodiment includes maintaining an aggregated and consistent perspective of issues within a business unit or across an enterprise that is accurate and transparent. In particular embodiments, this helps ensure that issues and future/emerging issues are well understood and addressed within an enterprise, with the positive intent to mitigate exposure to the enterprise. The regular reporting and assessment of issues facilitates remediation of current and future risks within increased speed and in a timely manner. Another technical advantage of an embodiment includes automatically converting future issues into current issues based on parameters associated with the issues data. This further enables users in an organization to evaluate issues based on their impact date, priority, severity, or other criteria identified by the organization. Yet another technical advantage of an embodiment includes creating action items to define a measurable review of risk mitigation that provides management with indicators necessary to promote effective mitigation control plans and help drive current and future investment decisions. This may also assist management in creating incentives for achieving particular risk mitigation milestones.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus, comprising:
an interface operable to receive a plurality of issues associated with an enterprise, wherein each issue is a selected one of a future risk and a current risk;
a memory operable to store the plurality of issues; and
a processor communicatively coupled to the interface and the memory, the processor operable to:
aggregate the plurality of issues;
filter the plurality of issues by executing a predefined rule set to determine a set of issues for analysis;
create a report comprising the set of issues for analysis; and
transmit the report to a user.

2. The apparatus of claim 1, wherein the processor is further operable to:
determine a status of an action item associated with an issue in the set of issues;
if the status of the action item is open, monitor the issue and associated action item; and
if the status of the action item is closed, remove the issue from the set of issues.

3. The apparatus of claim 1, wherein the predefined rule set comprises instructions that, when executed by the processor, determine which issues of the plurality of issues to include in the report for the user.

4. The apparatus of claim 1, wherein the processor is further operable to:
execute conversion rules to evaluate the future risk; and
convert the future risk into a current risk according to the executed conversion rules.

5. The apparatus of claim 4, wherein the conversion rules comprise instructions that, when executed by a processor, determine when to convert the future risk into a current risk based on at least one of the following: risk severity, risk probability, line of business priority, and estimated impact date.

6. The apparatus of claim 1, wherein the interface is operable to receive the plurality of issues from at least one of the following: a computer terminal and aggregation module.

7. The apparatus of claim 1, wherein the processor is operable to aggregate, filter, create a report and transmit the report on a predetermined schedule.

8. An method, comprising:
receiving a plurality of issues associated with an enterprise using an interface, wherein each issue is a selected one of a future risk and a current risk;
storing the plurality of issues in a memory;
aggregating, using a processor, the plurality of issues;
filtering, using the processor, the plurality of issues by executing a predefined rule set to determine a set of issues for analysis;
creating a report comprising the set of issues for analysis; and
transmitting the report to a user.

9. The method of claim 8, further comprising:
determining a status of an action item associated with an issue in the set of issues;
if the status of the action item is open, monitoring the issue and associated action item; and
if the status of the action item is closed, removing the issue from the set of issues.

10. The method of claim 8, wherein the predefined rule set comprises instructions that, when executed by the processor, determine which issues of the plurality of issues to include in the report for the user.

11. The method of claim 8, further comprising:
executing conversion rules to evaluate the future risk; and
converting the future risk into a current risk according to the executed conversion rules.

12. The method of claim 11, wherein executing conversion rules comprises determining when to convert the future risk into a current risk based on at least one of the following: risk severity, risk probability, line of business priority, and estimated impact date.

13. The method of claim 8, further comprising receiving the plurality of issues from at least one of the following: a computer terminal and aggregation module.

14. The method of claim 8, wherein aggregating, filtering, creating a report and transmitting the report occurs on a predetermined schedule.

15. A non-transitory computer-readable medium comprising instructions, the instructions, when executed by a processor, operable to:
receive a plurality of issues associated with an enterprise using an interface, wherein each issue is a selected one of a future risk and a current risk;
store the plurality of issues;
aggregate the plurality of issues;
filter the plurality of issues by executing a predefined rule set to determine a set of issues for analysis;
create a report comprising the set of issues for analysis; and
transmit the report to a user.

16. The non-transitory computer-readable medium of claim 15, wherein the instructions are further operable to:
determine a status of an action item associated with an issue in the set of issues;
if the status of the action item is open, monitor the issue and associated action item; and
if the status of the action item is closed, remove the issue from the set of issues.

17. The non-transitory computer-readable medium of claim 15, wherein the predefined rule set comprises instructions that, when executed by the processor, determine which issues of the plurality of issues to include in the report for the user.

18. The non-transitory computer-readable medium of claim 15, wherein the instructions are further operable to:
execute conversion rules to evaluate the future risk; and
convert the future risk into a current risk according to the executed conversion rules.

19. The non-transitory computer-readable medium of claim 18, wherein executing the conversion rules comprises determining when to convert the future risk into a current risk based on at least one of the following: risk severity, risk probability, line of business priority, and estimated impact date.

20. The non-transitory computer-readable medium of claim 15, wherein the instructions are further operable to aggregate, filter, create a report and transmit the report on a predetermined schedule.
